(19) United States
(12) Patent Application Publication
(10) Pub. No.: US 2023/0037236 A1
(43) Pub. Date: Feb. 2, 2023

(54) KEY STRUCTURE

(71) Applicant: Primax Electronics Ltd., Taipei (TW)

(72) Inventors: Chuang-Shu Jhuang, Taipei (TW); Zhi-Hui Zeng, Taipei (TW)

(21) Appl. No.: 17/412,261

(22) Filed: Aug. 26, 2021

(30) Foreign Application Priority Data
Jul. 30, 2021 (CN) 202110869973.9

(51) Int. Cl. H01H 13/14; H01H 13/7065; H01H 13/10; H01H 3/12

(52) U.S. Cl. CPC H01H 13/14; H01H 3/125; H01H 13/10; H01H 13/7065; H01H 2233/07

(57) ABSTRACT

A key structure includes a keycap, a base plate and a connecting element. The keycap includes a sliding groove located at a bottom side the keycap. A top surface of the sliding groove faces a portion of the bottom surface of the keycap. Moreover, at least one of the top surface of the sliding groove and the portion of the bottom surface of the keycap is a slant surface. The base plate is located under the keycap. The connecting element is connected between the keycap and the base plate.

### FIELD OF THE INVENTION

The present invention relates to a key structure.

### BACKGROUND OF THE INVENTION

With increasing development of science and technology, a variety of electronic devices are designed in views of convenience and user-friendliness. For helping the user well operate the electronic devices, the electronic devices are gradually developed in views of humanization. The input devices of the common electronic devices include for example mouse devices, keyboard devices, trackball devices, or the like. Via the keyboard device, texts or symbols can be inputted into the computer system directly. As a consequence, most users and most manufacturers of input devices pay much attention to the development of keyboard devices.

However, while the key structure of the keyboard device is pressed down, the key structure may shake and generate noise. In other words, the experience feeling is usually unsatisfactory to the user.

Therefore, there is a need of providing an improved key structure in order to overcome the drawbacks of the conventional technologies.

### SUMMARY OF THE INVENTION

In accordance with an aspect of the present invention, a key structure is provided. The key structure includes a keycap, a base plate and a connecting element. The keycap includes a sliding groove located at a bottom side the keycap. A top surface of the sliding groove faces a portion of the bottom surface of the keycap. Moreover, at least one of the top surface of the sliding groove and the portion of the bottom surface of the keycap is a slant surface. The base plate is located under the keycap. The connecting element is connected between the keycap and the base plate.

In an embodiment, the slant surface is a flat slant surface.

In an embodiment, the top surface of the sliding groove and the portion of the bottom surface of the keycap are not in parallel with each other.

In an embodiment, a gap between the top surface of the sliding groove and the portion of the bottom surface of the keycap is gradually increased from a position away from an edge part of the keycap to a position close to the edge part of the keycap.

In an embodiment, the portion of the bottom surface of the keycap is the slant surface.

In an embodiment, the slant surface is protruded from the bottom surface of the keycap. Moreover, a thickness of the slant surface at a position close to an edge part of the keycap is smaller than a thickness of the slant surface at a position away from the edge part of the keycap.

In an embodiment, a first part of the connecting element is disposed within the sliding groove. While the keycap is pressed down, the first part of the connecting element is slid in a direction toward an edge part of the keycap.

In an embodiment, the connecting element includes an outer frame of a scissors-type connecting element, and the first part of the connecting element is a portion of the outer frame.

In an embodiment, the base plate includes a hooking structure located at a top side of the base plate. The hooking structure includes a hook part. A second part of the connecting element is located under the hook part. A bottom surface of the hook part is an additional slant surface.

In an embodiment, the connecting element includes an inner frame of a scissors-type connecting element, and the second part of the connecting element is a portion of the inner frame.

In an embodiment, a position of the bottom surface of the hook part close to an edge part of the base plate is at a level higher than a position of the bottom surface of the hook part away from the edge part of the base plate.

In an embodiment, the base plate includes a coupling structure located at a top side of the base plate. The connecting element is a stabilizer bar, and a portion of the stabilizer bar faces a bottom surface of an upper part of the coupling structure. The bottom surface of the upper part of the coupling structure is an additional slant surface.

In an embodiment, a position of the bottom surface of the upper part close to an edge part of the base plate is at a level lower than a position of the bottom surface of the upper part away from the edge part of the base plate.

In accordance with another aspect of the present invention, a key structure is provided. The key structure includes a keycap, a base plate and a connecting element. The base plate located under the keycap. The base plate includes a coupling structure. The coupling structure is located at a top side of the base plate. A bottom surface of an upper part of the coupling structure is a slant surface. The connecting element is connected between the keycap and the base plate. A portion of the stabilizer bar faces the bottom surface of the upper part of the coupling structure.

In an embodiment, the connecting element is a stabilizer bar. Moreover, and a position of the bottom surface of the upper part close to an edge part of the base plate is at a level lower than a position of the bottom surface of the upper part away from the edge part of the base plate.

From the above descriptions, the present invention provides the key structure. In the key structure, the portion of the keycap (or the base plate) in contact with the connecting element is equipped with a slant surface. Due to the slant surface, the gap between components because of tolerance or size can be absorbed. Consequently, the shaking problem and the noise generation problem can be effectively solved.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic exploded view illustrating a key structure according to a first embodiment of the present invention;

FIG. 2 is a schematic perspective view illustrating the keycap of the key structure according to the first embodiment of the present invention;

FIG. 3 is a schematic cross-sectional view illustrating the keycap of the key structure according to the first embodiment of the present invention;

FIG. 4 is a schematic cross-sectional view illustrating the relationship between the keycap and the connecting element of the key structure according to the first embodiment of the present invention, in which the key structure is not pressed down;

FIG. 5 is a schematic cross-sectional view illustrating the relationship between the keycap and the connecting element of the key structure according to the embodiment of the present invention, in which the key structure is pressed down;

FIG. 6 is a schematic cross-sectional view illustrating the relationship between the connecting element and the base plate of the key structure according to the first embodiment of the present invention, in which the key structure is not pressed down;

FIG. 7 is a schematic cross-sectional view illustrating the relationship between the connecting element and the base plate of the key structure according to the first embodiment of the present invention, in which the key structure is pressed down;

FIG. 8 is a schematic cross-sectional view illustrating the relationship between the keycap, the connecting element and the base plate of a key structure according to a second embodiment of the present invention, in which the key structure is not pressed down; and

FIG. 9 is a schematic cross-sectional view illustrating the relationship between the keycap, the connecting element and the base plate of the key structure according to the second embodiment of the present invention, in which the key structure is pressed down.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

In this context, the spatial relative terms (e.g., “under”, “over” or the like) are used to describe the relative relationship between one element or feature and another element or feature in the drawings. The true meanings of these spatial relative terms include other orientations. For example, when the drawing is turned upside down by 180 degrees, the relationship between one element and another element may be changed from “under” to “over”. The spatial relative description used herein should be explained in the same way.

As mentioned above, while the key structure of the existing keyboard device is pressed down, the key structure may shake and generate noise. In other words, the experience feeling is usually unsatisfactory to the user. The inventors found that the above drawbacks of the conventional technologies were resulted from the gap between the connecting element and the keycap (or the base plate). For overcoming these drawbacks, the present invention provides a key structure. In the key structure of the present invention, the portion of the keycap (or the base plate) in contact with the connecting element is equipped with a slant surface. Due to the slant surface, the gap between components because of tolerance or size can be absorbed. Consequently, the shaking problem and the noise generation problem can be effectively solved. Some examples of the key structure of the present invention will be described as follows.

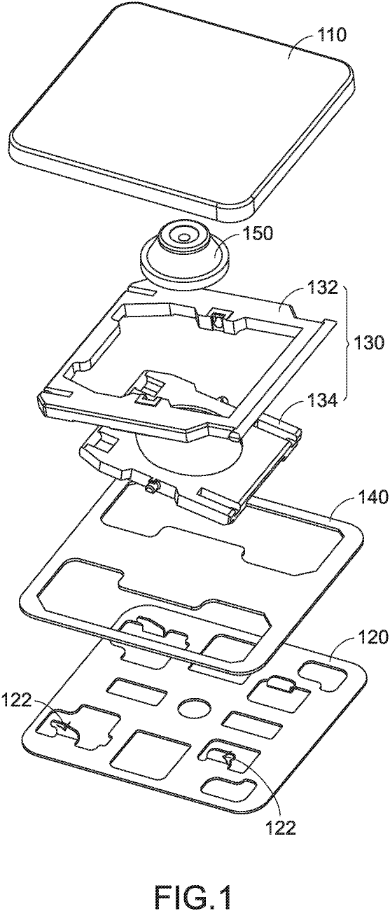

Generally, a keyboard device comprises plural key structures. FIG. 1 is a schematic exploded view illustrating a key structure according to a first embodiment of the present invention. As shown in FIG. 1, the key structure comprises a keycap 110, a bae plate 120 and a connecting element 130. The base plate 120 is located under the keycap 110. The connecting element 130 is connected between the keycap 110 and the base plate 120. In an embodiment, the connecting element 130 is a scissors-type connecting element. The scissors-type connecting element 130 includes an outer frame 132 and an inner frame 134. The outer frame 134 is combined with the inner frame 132. In addition, the outer frame 134 can be swung relative to inner frame 132.

In the embodiment of FIG. 1, the key structure further includes a membrane circuit board 140 and an elastic element (also referred as an elastomer) 150. The membrane circuit board 140 is located under the keycap 110 and the connecting element 130. In an embodiment, the membrane circuit board 140 includes plural film layers (not shown) and plural membrane switches (not shown). The plural film layers are arranged in a stacked form. The elastic element 150 is disposed on the membrane circuit board 140. The elastic element 150 is made of a non-conductive elastic material such as rubber or silicone. While the keycap 110 is pressed down, a triggering part of the elastic element 150 is gradually descended and contacted with the corresponding membrane switch of the membrane circuit board 140.

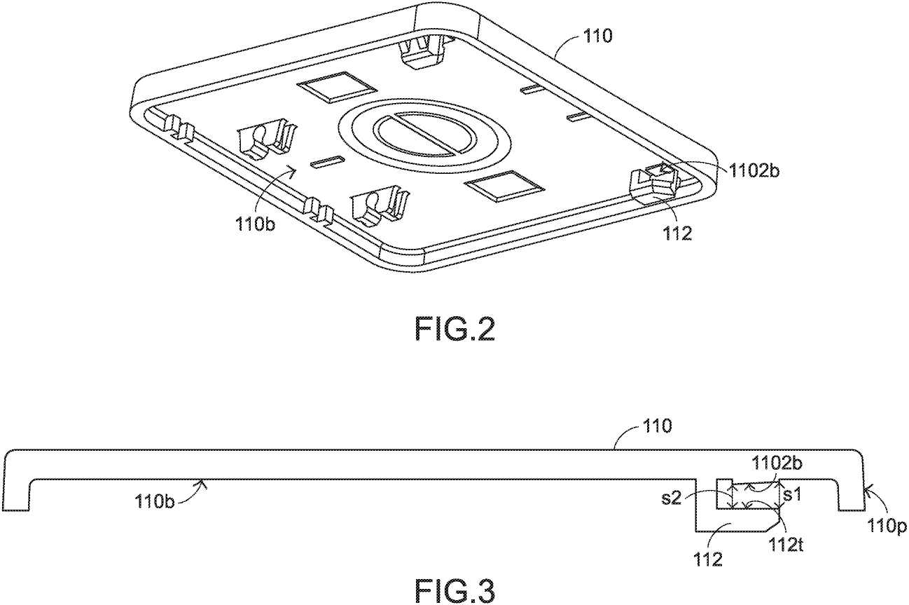

FIG. 2 is a schematic perspective view illustrating the keycap of the key structure according to the first embodiment of the present invention. FIG. 3 is a schematic cross-sectional view illustrating the keycap of the key structure according to the first embodiment of the present invention. As shown in FIGS. 2 and 3, the keycap 110 includes a sliding groove 112. The sliding groove 112 is located under a bottom surface 110b of the keycap 110. In addition, the sliding groove 112 is connected with the bottom surface 110b of the keycap 110.

Please refer to FIGS. 2 and 3 again. A top surface 112t of the sliding groove 112 and a portion 1102b of the bottom surface 110b of the keycap 110 face each other. At least one of the top surface 112t of the sliding groove 112 and the portion 1102b of the bottom surface 110b of the keycap 110 is a slant surface. That is, the top surface of the sliding groove is a slant surface (not shown), or the portion 1102b of the bottom surface 110b of the keycap 110 is a slant surface. For example, in the embodiment of FIGS. 2 and 3, the portion 1102b of the bottom surface 110b of the keycap 110 is the slant surface. Alternatively, the top surface of the sliding groove and the portion of the bottom surface of the keycap are both slant surfaces. In the embodiment of FIGS. 2 and 3, the slant surface is a flat slant surface. It is noted that the slant surface is not restricted to the flat slant surface. That is, the profile of the slant surface may be adjusted according to the practical requirements.

Please refer to FIG. 3. In an embodiment, the top surface 112t of the sliding groove 112 and the portion 1102b of the bottom surface 110b of the keycap 110 are not in parallel with each other. Moreover, the gap between the top surface 112t of the sliding groove 112 and the portion 1102b of the bottom surface 110b of the keycap 110 is not uniform. As shown in FIG. 3, the gap is gradually increased from the position away from an edge part 110p of the keycap 110 (i.e., the position close to the inner side of the sliding groove 112) to the position close to the edge part 110p of the keycap 110 (i.e., the position close to the outer side of the sliding groove 112). That is, the gap s1 between the top surface 112t of the sliding groove 112 and the portion 1102b of the bottom surface 110b of the keycap 110 at the position close to the edge part 110p of the keycap 110 (i.e., the position close to the outer side of the sliding groove 112) is larger than the gap s2 between the top surface 112t of the sliding groove 112 and the portion 1102b of the bottom surface 110b of the keycap 110 at the position away from the edge part 110p of the keycap 110 (i.e., the position close to the inner side of the sliding groove 112).

As shown in FIGS. 2 and 3, the portion 1102b of the bottom surface 110b of the keycap 110 is a slant surface. In an embodiment, the slant surface is protruded from the bottom surface 110b of the keycap 110. Moreover, the thickness of the slant surface at the position close to the edge part 110p of the keycap 110 is smaller than the thickness of the slant surface at the position away from the edge part 110p of the keycap 110. In another embodiment, the top surface of the sliding groove is a slant surface (not shown). Alternatively, the top surface of the sliding groove and the portion of the bottom surface of the keycap are slant surfaces (not shown). By controlling the inclination angle of the slant surface, the gap at the position close to the inner side of the sliding groove is smaller, and the gap at the position close to the outer side of the sliding groove is larger.

In an embodiment, an end of the portion 1102b of the bottom surface 110b of the keycap 110 close to the edge part 110p of the keycap 110 is substantially aligned with an end of the top surface 112t of the sliding groove 112 close to the edge part 1109 of the keycap 110. It is noted that the position of the end of the portion 1102b and the position of the end of the top surface 112t are not restricted. That is, the position of the end of the portion 1102b of the bottom surface 110b of the keycap 110 and/or the position of the end of the top surface 112t of the sliding groove 112 may be varied according to the practical requirements.

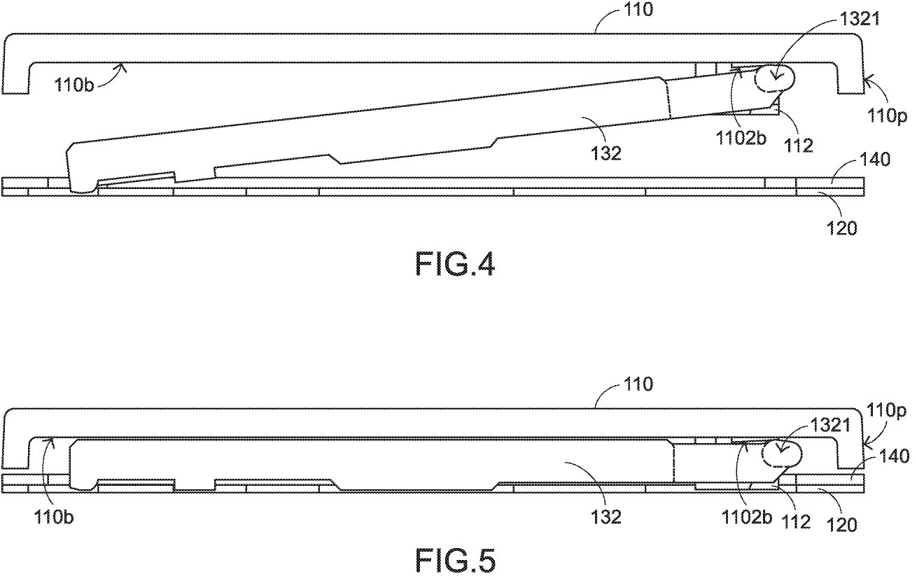

FIG. 4 is a schematic cross-sectional view illustrating the relationship between the keycap and the connecting element of the key structure according to the first embodiment of the present invention, in which the key structure is not pressed down. As shown in FIG. 4, the connecting element is the outer frame 132 of the scissors-type connecting element. It is noted that the example of the connecting element is not restricted. For example, any other element that can be cooperatively operated with the sliding groove 112 and slide within the sliding groove 112 can be used as the connecting element of the present invention. A first part 1321 of the connecting element (e.g., the outer frame 132) is disposed within the sliding groove 112. As shown in FIGS. 3 and 4, the gap at the position close to the inner side of the sliding groove 132 is smaller. Consequently, the gap between the first part 1321 of the outer frame 132 and the portion 1102b of the bottom surface 110b of the keycap 110 and the gap between the first part 1321 of the outer frame 132 and the top surface 112t of the sliding groove 112 can reach minimum or even zero.

Please refer to FIGS. 3 and 4 again. By controlling the inclination angle of the slant surface, the first part 1321 of the outer frame 132 and the slant surface are contacted with each other, and there is tiny interference between the first part 1321 of the outer frame 132 and the slant surface. Consequently, the gap between the first part 1321 of the outer frame 132 and the sliding groove 112 (or the bottom of the keycap 110) because of tolerance or size can be absorbed. Due to this structural design, the gap between the first part 1321 of the outer frame 132 and the portion 1102b of the bottom surface 110b of the keycap 110 and the gap between the first part 1321 of the outer frame 132 and the top surface 112t of the sliding groove 112 can reach minimum or even zero. Consequently, when the key structure is pressed down, no noise (e.g., the noise caused by audio resonance, e.g., the noise like the buzzing sound from the bee wings vibration) is generated. In practice, the interference amount between the first part 1321 of the outer frame 132 and the slant surface can be adjusted according to the size parameters of the components. For example, the interference amount is in the range between 0.01 mm and 0.04 mm (e.g., 0.02 mm or 0.03 mm), or any value between any two values.

In an embodiment of FIG. 3, the inclination angle between the slant surface (e.g., the portion 1102b of the bottom surface 110b of the keycap 110) and the horizontal plane (e.g., the bottom surface 110b of the keycap 110) is in the range between 2 degrees and 12 degrees (e.g., 3 degrees, 4 degrees, 5 degrees, 6 degrees, 7 degrees, 8 degrees, 9 degrees, 10 degrees or 11 degrees), or any value between any two values.

FIG. 5 is a schematic cross-sectional view illustrating the relationship between the keycap and the connecting element of the key structure according to the embodiment of the present invention, in which the key structure is pressed down. Please refer to FIGS. 4 and 5. While the keycap 110 is pressed down, the first part 1321 of the outer frame 132 is slid in the direction toward the edge part 110p of the keycap 110. Please refer to FIGS. 3, 4 and 5. While the first part 1321 of the outer frame 132 is slid in the direction toward the edge part 110p of the keycap 110, the first part 1321 of the outer frame 132 is gradually slid from the position corresponding to the minimum gap (or even zero gap) to the position corresponding to the maximum gap. In other words, the gap between the first part 1321 of the outer frame 132 and the portion 1102b of the bottom surface 110b of the keycap 110 and/or the gap between the first part 1321 of the outer frame 132 and the top surface 112t of the sliding grove 112 is gradually released. Consequently, while the key structure is pressed down, the key structure is stably moved downwardly without shaking, and almost no noise is generated.

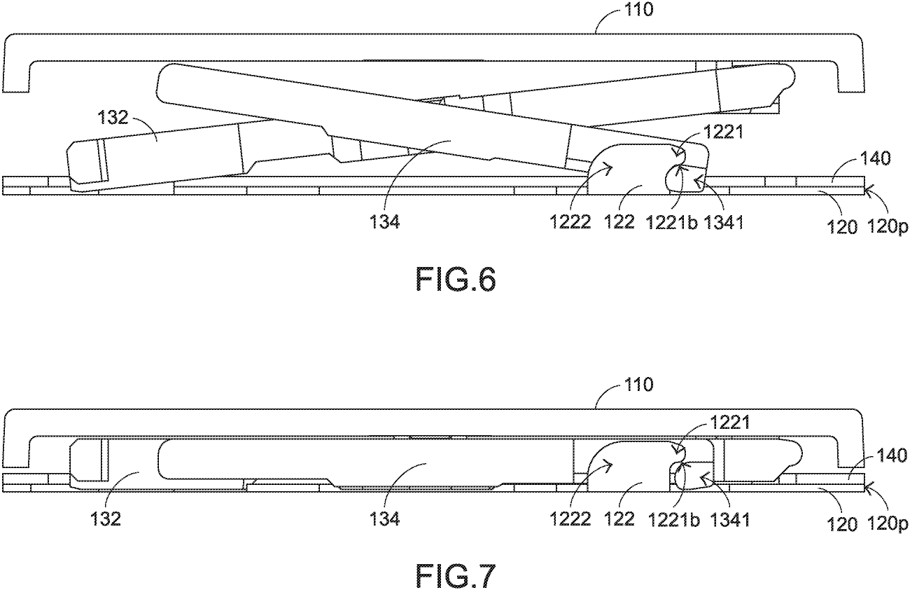

FIG. 6 is a schematic cross-sectional view illustrating the relationship between the connecting element and the base plate of the key structure according to the first embodiment of the present invention, in which the key structure is not pressed down. As shown in FIG. 6, the base plate 120 includes a hooking structure 122 located at a top side of the base plate 120. The hooking structure 122 includes a hook part 1221. The hooking structure 122 further includes a positioning part 1222. The positioning part 1222 is connected with the hook part 1221. Moreover, the hook part 1221 is connected with the base plate 120 through the positioning part 1222. In this embodiment, the connecting element is the inner frame 134 of the scissors-type connecting element. It is noted that the example of the connecting element is not restricted. For example, any other element that can be cooperatively operated with the hook part 1221 and slide within the hook part 1221 can be used as the connecting element of the present invention. A second part 1341 of the connecting element (e.g., the inner frame 134) is located under the hook part 1221. A bottom surface 1221b of the hook part 1221 faces the second part 1341 of the connecting element.

The bottom surface 1221b of the hook part 1221 is a slant surface. In an embodiment, the slant surface is a curvy slant surface. It is noted that the slant surface is not restricted to the curvy slant surface. That is, the profile of the slant surface may be adjusted according to the practical requirements. Please refer to FIG. 6 again. The position of the bottom surface 1221b of the hook part 1221 close to an edge part 120p of the base plate 120 (i.e., the position close to the outer side of the hook part 1221) is at a level higher than the position of the bottom surface 1221b of the hook part 1221 away from the edge part 120p of the base plate 120 (i.e., the position close to the inner side of the hook part 1221). In other words, the altitude of the bottom surface 1221b of the hook part 1221 close to the inner side of the hook part 1221 is lower, and the altitude of the bottom surface 1221b of the hook part 1221 close to the outer side of the hook part 1221 is higher. Since the altitude of the bottom surface 1221b of the hook part 1221 close to the inner side of the hook part 1221 is lower, the gap between the second part 1341 of the inner frame 134 and the hook part 1221 can reach minimum or even zero.

Please refer to FIG. 6 again. By controlling the inclination angle of the slant surface (i.e., the bottom surface 1221b of the hook part 1221), the second part 1341 of the inner frame 134 and the slant surface are contacted with each other, and there is tiny interference between the second part 1341 of the inner frame 134 and the slant surface. Consequently, the gap between the hook part 1221 and the second part 1341 of the inner frame 134 because of tolerance or size can be absorbed. Due to this structural design, the gap between the second part 1341 of the inner frame 134 and the bottom surface 1221b of the hook part 1221 can reach minimum or even zero. Consequently, when the key structure is pressed down, no noise (e.g., the noise caused by audio resonance, e.g., the noise like the buzzing sound from the bee wings vibration) is generated. In practice, the interference strength between the second part 1341 and the bottom surface 1221b of the hook part 1221 can be adjusted according to the size parameters of the components. For example, the interference amount is in the range between 0.01 mm and 0.04 mm (e.g., 0.02 mm or 0.03 mm), or in the range between any other two values.

FIG. 7 is a schematic cross-sectional view illustrating the relationship between the connecting element and the base plate of the key structure according to the first embodiment of the present invention, in which the key structure is pressed down. Please refer to FIGS. 6 and 7. While the keycap 110 is pressed down, the second part 1341 of the inner frame 134 is slid in the direction toward the edge part 120p of the base plate 120. While the second part 1341 of the inner frame 134 is slid in the direction toward the edge part 120p of the base plate 120, the second part 1341 of the outer frame 134 is gradually slid from the position corresponding to the minimum gap (or even zero gap) to the position corresponding to the maximum gap. In other words, the gap between the second part 1341 of the inner frame 134 and the bottom surface 1221b of the hook part 1221 is gradually released. Consequently, while the key structure is pressed down, the key structure is stably moved downwardly without shaking, and almost no noise is generated.

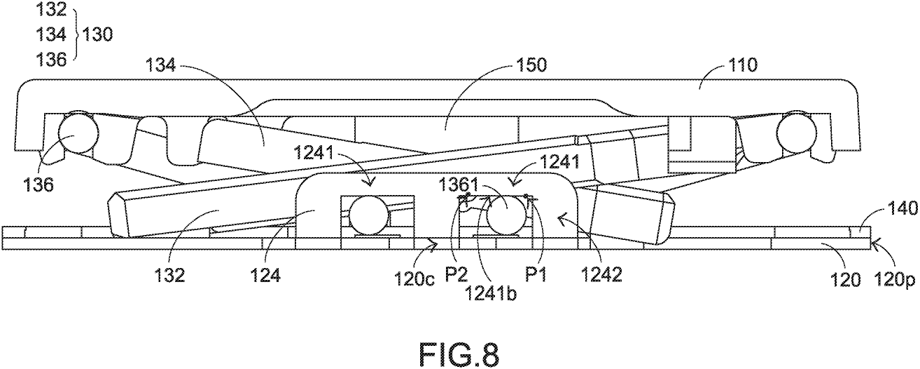

FIG. 8 is a schematic cross-sectional view illustrating the relationship between the keycap, the connecting element and the base plate of a key structure according to a second embodiment of the present invention, in which the key structure is not pressed down. As shown in FIG. 8, the base plate includes a coupling structure 124 located at a top side of the base plate 120. The coupling structure 124 includes an upper part 1241. The coupling structure 124 further includes a lateral part 1242 connected with the upper part 1241. Moreover, the upper part 1241 is connected with the base plate 120 through the lateral part 1242. At least one opening (not marked) is defined by the upper part 1241 and the lateral part 1242 collaboratively. In addition, the opening is a close-type opening. In an embodiment, the connecting element 130 includes at least one stabilizer bar 136. A portion 1361 of the stabilizer bar 136 is penetrated through the opening. In an embodiment, the portion 1361 of the stabilizer bar 136 faces a bottom surface 1241b of the upper part 1241 of the coupling structure 124. Moreover, the portion 1361 of the stabilizer bar 136 is contacted with the bottom surface 1241b of the upper part 1241 of the coupling structure 124.

The bottom surface 1241b of the upper part 1241 of the coupling structure 124 is a slant surface. In an embodiment, the slant surface is a flat slant surface. It is noted that the slant surface is not restricted to the flat slant surface. That is, the profile of the slant surface may be adjusted according to the practical requirements. In the embodiment of FIG. 8, the position P1 of the bottom surface 1241b of the upper part 1241 close to the edge part 120p of the base plate 120 is at a level lower than the position P2 of the bottom surface 1241b of the upper part 1241 away from the edge part 120p of the base plate 120 (i.e., the position close to a center part 120c of the base plate 120). In other words, the altitude of the bottom surface 1241b of the upper part 1241 at the position close to the outer side of the coupling structure 124 is lower, and the altitude of the bottom surface 1241b of the upper part 1241 at the position close to the middle region of the coupling structure 124 is higher. Since the altitude of the bottom surface 1241b of the upper part 1241 at the position close to the outer side of the coupling structure 124 is lower, the gap between the portion 1361 of the stabilizer bar 136 and the bottom surface 1241b of the upper part 1241 can reach minimum or even zero.

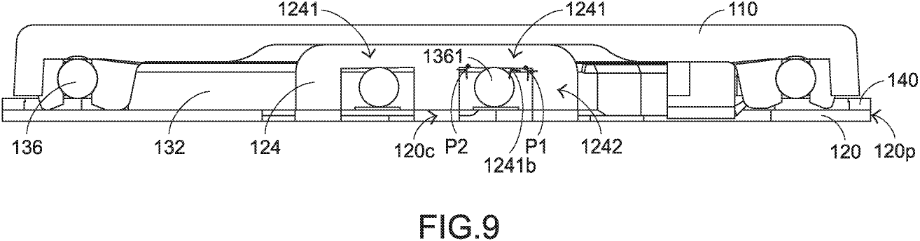

FIG. 9 is a schematic cross-sectional view illustrating the relationship between the keycap, the connecting element and the base plate of the key structure according to the second embodiment of the present invention, in which the key structure is pressed down. Please refer to FIGS. 8 and 9. While the keycap 110 is pressed down, the portion 1361 of the stabilizer bar 136 is slid in the direction toward the center part 120c of the base plate 120. While the portion 1361 of the stabilizer bar 136 is slid to the center part 120c of the base plate 120, the portion 1361 of the stabilizer bar 136 is gradually slid from the position corresponding to the minimum gap (or even zero gap) to the position corresponding to the maximum gap. In other words, the gap between the portion 1361 of the stabilizer bar 136 and the bottom surface 1241b of the upper part 1241 is gradually released. Consequently, while the key structure is pressed down, the key structure is stably moved downwardly without shaking, and almost no noise is generated.

Please refer to FIG. 8 again. The key structure according to the second embodiment of the present invention includes a keycap 110, the base plate 120 and the connecting element 130. The base plate 120 is located under the keycap 110. The base plate includes the coupling structure 124 located at the top side of the base plate 120. The bottom surface 1241b of the upper part 1241 of the coupling structure 124 is the slant surface. In an embodiment, the coupling structure 124 further includes the lateral part 1242 connected with the upper part 1241. Moreover, the upper part 1241 is connected with the base plate 120 through the lateral part 1242. At least one opening (not marked) is defined by the upper part 1241 and the lateral part 1242 collaboratively. In addition, the opening is a close-type opening.

The connecting element 130 is connected between the keycap 110 and the base plate 120. A portion of the connecting element 130 faces the bottom surface 1241b of the upper part 1241 of the coupling structure 124. In an embodiment, the connecting element 130 includes the stabilizer bar 136. A portion 1361 of the stabilizer bar 136 is penetrated through the opening. In an embodiment, the portion 1361 of the stabilizer bar 136 faces a bottom surface 1241b of the upper part 1241 of the coupling structure 124. Moreover, the portion 1361 of the stabilizer bar 136 is contacted with the bottom surface 1241b of the upper part 1241 of the coupling structure 124. In an embodiment, the position P1 of the bottom surface 1241b of the upper part 1241 close to the edge part 120p of the base plate 120 is at a level lower than the position P2 of the bottom surface 1241b of the upper part 1241 away from the edge part 120p of the base plate 120 (i.e., the position close to the center part 120c of the base plate 120). In other words, the altitude of the bottom surface 1241b of the upper part 1241 at the position close to the outer side of the coupling structure 124 is lower, and the altitude of the bottom surface 1241b of the upper part 1241 at the position close to the middle region of the coupling structure 124 is higher. Since the altitude of the bottom surface 1241b of the upper part 1241 at the position close to the outer side of the coupling structure 124 is lower, the gap between the portion 1361 of the stabilizer bar 136 and the bottom surface 1241b of the upper part 1241 can reach minimum or even zero.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

1. A key structure, comprising:
a keycap comprising a sliding groove located at a bottom side the keycap, and a top surface of the sliding groove facing a portion of a bottom surface of the keycap, wherein the portion of the bottom surface of the keycap is a slant surface;
a base plate located under the keycap; and
a connecting element connected between the keycap and the base plate and a first part of the connecting element is disposed within the sliding groove; wherein the slant surface is protruded from the bottom surface of the keycap, wherein a thickness of the slant surface at a position close to an edge part of the keycap is smaller than a thickness of the slant surface at a position away from the edge part of the keycap, so that the gap at the position close to the inner side of the sliding groove is smaller than the gap at the position close to the outer side of the sliding groove.

2. The key structure according to claim 1, wherein the slant surface is a flat slant surface.

3. The key structure according to claim 1, wherein the top surface of the sliding groove and the portion of the bottom surface of the keycap are not in parallel with each other.

4. The key structure according to claim 1, wherein a gap between the top surface of the sliding groove and the portion of the bottom surface of the keycap is gradually increased from a position away from an edge part of the keycap to a position close to the edge part of the keycap.

5. (canceled)

6. (canceled)

7. The key structure according to claim 1, wherein a first part of the connecting element is disposed within the sliding groove, wherein while the keycap is pressed down, the first part of the connecting element is slid in a direction toward an edge part of the keycap.

8. The key structure according to claim 7, wherein the connecting element includes an outer frame of a scissors connecting element, and the first part of the connecting element is a portion of the outer frame.

9. The key structure according to claim 1, wherein the base plate comprises a hooking structure located at a top side of the base plate, wherein the hooking structure comprises a hook part, and a second part of the connecting element is located under the hook part, and a bottom surface of the hook part is an additional slant surface.

10. The key structure according to claim 9, wherein the connecting element includes an inner frame of a scissors connecting element, and the second part of the connecting element is a portion of the inner frame.

11. The key structure according to claim 9, wherein a position of the bottom surface of the hook part close to an edge part of the base plate is at a level higher than a position of the bottom surface of the hook part away from the edge part of the base plate.
